(19) United States
(12) Patent Application Publication
(10) Pub. No.: US 2007/0204183 A1
(43) Pub. Date: Aug. 30, 2007

(54) Method and apparatus for processing abnormal conditions of a backup-type power supply system

(75) Inventor: Tsung-Chun Chen, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/360,592

(22) Filed: Feb. 24, 2006

(51) Int. Cl. G06F 1/00

(52) U.S. Cl. 713/323

(57) ABSTRACT

A method and an apparatus to process abnormal conditions of a backup-type power supply system aims to provide duty loading values to allow the backup-type power supply system to independently monitor individual power supply modules so that operators are informed earlier of the power supply modules that are aging or likely to malfunction, thereby replacement can be made timely. Thus overloading or heavy loading of the remained power supply modules in normal conditions can be prevented. The life span of the backup-type power supply system increases.

### FIELD OF THE INVENTION

The present invention relates to a method and apparatus for processing abnormal conditions of a backup-type power supply system and particularly to a method and an apparatus that provide a duty loading value to allow the back-up type power supply system to independently monitor individual power supply modules so that the power supply modules can be replaced in advance before malfunction occurs.

### BACKGROUND OF THE INVENTION

The conventional backup-type power supply system for an industrial computer usually adopts a N+M combination mode to maintain continuous operation of the industrial computer without interrupting power supply. In general, “N” means the number of power supply modules that can jointly meet the total power requirement of the industrial computer, and “M” means the number of power supply modules allowable in the malfunction condition. The commonly adopted design is N+1 architecture. In the event that one of the power supply modules malfunctions, the system generates an alarm signal to alert operators to do repairs or replacement. Take a power supply system adopting a 2+1 architecture as an example, to evenly distribute electric power for an existing load, each power supply module has to share ⅓ of the output power. But in fact each power supply module has a different aging and attenuating condition, hence the ratio may be adjusted instantly to 30%:35%:45% in response to the actual output power of the power supply modules to become a normal loading or light loading condition. In the event that one set of the power supply modules malfunctions, the remained two sets of the power supply modules have to be adjusted to a heavy loading condition of 50%:50% or 40%:60%. Operators often have to replace the new power supply module before adjusting back to the relative ratio of the normal loading or light loading. However, the actual life span of each power supply module is different. The causes of malfunction also varies. It could happen that after the new power supply module has been installed, the relative ratio becomes 20%:20%:60%. And the first two power supply modules have been used for a period of time, while the last one is the new power supply module. This results in the new power supply module being used in the heavy loading condition continuously. Once malfunction occurs, at least two sets of the power supply modules are damaged at the same time. As a result, output power of the entire power supply system cannot meet the power requirement of the rear end electronic devices. The operation of the industrial computer is interrupted. Moreover, operators have to inspect every power supply module to determine which one is damaged. It is troublesome. In the general situation, the damaged power supply module has to be sent back to the original producer to do inspection and test. Operation of the industrial computer has to be stopped temporarily. This is against the fundamental purpose of providing non-stop power supply of the backup-type power supply system. In addition, after the new power supply module is installed, it is normally operating in a heavy loading or overloading condition. This accelerates damage of the new power supply module. This is especially true in the environment where overheating occurs and the power cannot be adjusted effectively. Some of the elements in the new power supply module are easily burnt out. As a result, users have to purchase new power supply modules frequently. Furthermore, with the burn-out of the power supply modules occurred frequently, the risk of fire breakout in the computer room also increases. This is because the power supply modules that are likely to malfunction often operate in abnormal conditions, and the operation temperature is often higher than the normal power supply modules. The final cause of damage on this type of power supply modules often is burn-out due to overheating. It is a great concern to industrial safety.

### SUMMARY OF THE INVENTION

The primary object of the present invention is to solve the aforesaid disadvantages. The present invention provides a duty loading value to allow a backup-type power supply system to independently monitor individual power supply modules so that the power supply module which is aging or likely malfunction can be identified and replaced in advance. Thereby overloading or heavy loading of the rest power supply modules can be prevented. The life span of the backup-type power supply system can increase.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flow chart of the method for processing abnormal conditions according to the invention.

FIG. 2 a schematic circuit block diagram of the present invention.

### DETAILED DESCRIPTION OF THE PREFERRED EMBODIMENTS

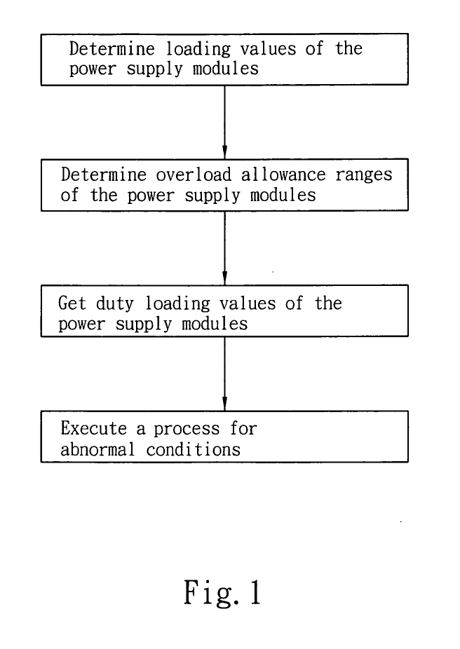

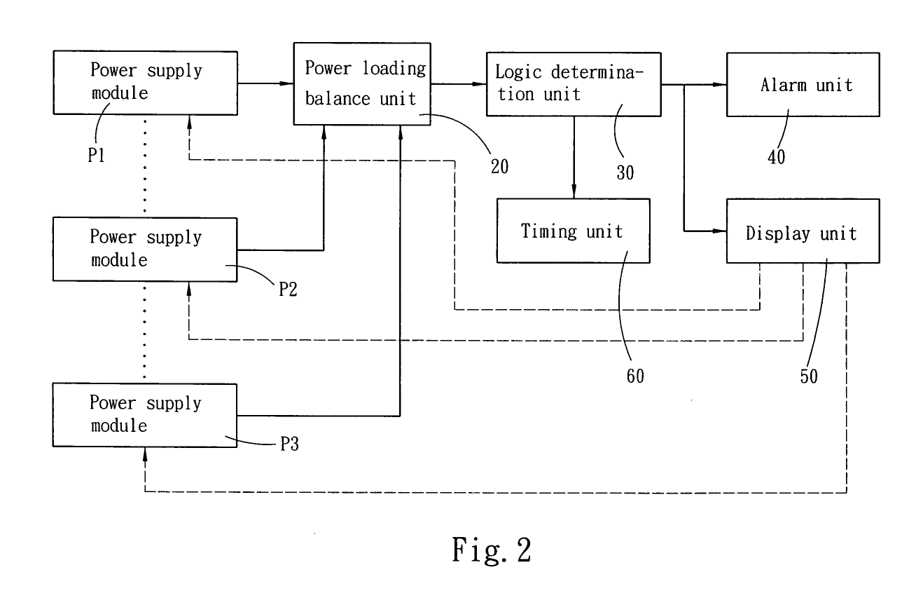

Please referring to FIGS. 1 and 2, the method for processing abnormal conditions of a backup-type power supply system of the invention is adopted for use on a backup-type power supply system that consists of a plurality of power supply modules P1-P3. In the event that any one of the power supply modules P1-P3 malfunctions, a corresponding action is executed. The method includes the following:

A. Determine loading values of the power supply modules P1-P3: According to total power loading value to be provided by the power supply system, the duty loading value of the individual power supply modules P1-P3 can be determined according to deliverable output power loading value of the individual power supply modules P1-P3 through a power loading balance unit 20 by adopting a power loading balance mode. In this embodiment that takes 2+1 architecture for the power supply modules P1-P3 as an example, the normal distribution ratio is P1:P2:P3=⅓:⅓:⅓. Assuming that PI and P2 are the power supply modules that have been used for a period of time and an attenuating condition exists, and P3 is a new power supply module; also assuming that the adjusted power distribution ratio is P1:P2:P3=25%:30%:45% (the ratio set forth above is merely an example to facilitate discussion, and is not the limitation of the invention); B. Determine overload allowable ranges of the power supply modules P1-P3: The overload allowable ranges can be determined by at least the following three approaches: 1. set the ranges according a relative ratio of the maximum duty loading value and the minimum duty loading value of the power supply modules P1-P3; 2. set between the duty loading value and the minimum duty loading value of the power supply modules P1-P3; 3. set between the duty loading value and the maximum duty loading value of the power supply modules P1-P3; 4. set between the minimum duty loading value and maximum duty loading value of the power supply modules P1-P3. The embodiment is based on item 4 previously discussed, and the overload allowable ranges are between 20%-80% and preset in a logic determination unit 30;

C. Get duty loading values of the power supply modules P1-P3: After the power supply system is activated, according to the power distribution ratio set on item A, get the duty loading values of the individual power supply modules P1-P3 by detecting of the logic determination unit 30. The detected duty loading values are output to a display unit 60 through a display signal; and

D. Execute a process for abnormal conditions: Assume that the power supply system has been used for a period of time, and the attenuation of the power supply modules P1 and P2 are serious, through the logic determination unit 30 whether the duty loading values of the power supply modules P1-P3 have exceeded the overload allowable ranges is determined; if it is positive, a corresponding process for abnormal conditions is executed, that may include cutting off the power supply modules P1-P3 that exceed the overload allowable ranges, or cutting off all the power supply modules P1-P3, or cutting off the power supply modules P1-P3 that exceed the overload allowable ranges and returning to the initial step to adjust anew the individual loading value of the remained power supply modules P1-P3; or the logic determination unit 30 first issues an alarm signal to an alarm unit 40 which may be a light emitting element (LED indication lamp set) or audio output element (a buzzer) to generate a sound signal, light signal or combination thereof to inform operators instantly to do replacement or repairs for the power supply modules P1-P3 that are likely to malfunction. Moreover, the alarm signal may also be sent to a remote monitor location via a communication network such as a line or wireless local area network (LAN), Intranet or Internet so that the monitors at the remote site can receive the message immediately. The process for abnormal conditions may further include a timing procedure. After the alarm signal has been sent, a timer 50 sets a time period. If the power supply modules P1-P3 are replaced, return to the initial step; otherwise, when the time period is elapsed, a driving signal is issued to cut off the power supply modules P1-P3. According to the invention, if the duty loading values of the power supply modules P1-P3 are adjusted to P1:P2:P3=15%:18%:67% or even P1:P2:P3=10%:10%:80% due to different attenuations, the alarm signal informs the operators to replace P1 and P2 at the same time to prevent P3 from in the heavy loading or overloading condition continuously, thereby to prevent P3 from heavy loading in the normal conditions to avoid accelerating of attenuation or overheating and resulting in damage of some elements.

Thus through the invention, the power supply modules P1-P3 can deliver balance power, and each of the power supply modules P1-P3 can be replaced individually according to different attenuation and used time period. Therefore undue damage of the new power supply modules P1-P3 can be eliminated. In addition, the process for abnormal conditions of the invention further provides an early protection mechanism. When the power supply modules P1-P3 are likely to malfunction, the power is cut off to request the operators to do replacement. Hence industrial safety concern such as fire breakout can be effectively prevented.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for processing abnormal conditions of a backup-type power supply system which includes a plurality of power supply modules that executes a corresponding action when one of the power supply modules malfunctions, comprising:
A. determining loading values of the individual power supply modules according to a total power loading value to be provided by the power supply system and deliverable output power loading values of the individual power supply modules derived in a power loading balance mode;
B. determining overload allowable ranges of the power supply modules;
C. getting duty loading values of the power supply modules; and
D. executing a process for abnormal conditions when the duty loading values of the power supply modules have been determined exceeding the overload allowable ranges.

2. The method of claim 1, wherein the executing a process for abnormal conditions is cutting off the power supply modules that exceed the overload allowable ranges.

3. The method of claim 1, wherein the executing a process for abnormal conditions is cutting off all of the power supply modules.

4. The method of claim 1, wherein the executing a process for abnormal conditions is cutting off the power supply modules that exceed the overload allowable ranges and returning to initial procedures to adjust anew the individual loading values of remained power supply modules.

5. The method of claim 1, wherein the executing a process for abnormal conditions includes sending an alarm signal.

6. The method of claim 5, wherein the alarm signal is a sound signal, a light signal or a combination thereof.

7. The method of claim 5, wherein the alarm signal is sent to a remote monitor end through a communication network which is a line or wireless local area network (LAN), an Intranet or the Internet.

8. The method of claim 5, wherein the executing a process for abnormal conditions includes a timing procedure by setting a time period after the alarm signal is sent, returning to initial procedures when the power supply modules are replaced, otherwise cutting off the power supply modules when they are not being replaced.

9. The method of claim 1, wherein the overload allowable ranges are set according a relative ratio of a maximum duty loading value and a minimum duty loading value of the power supply modules.

10. The method of claim 1, wherein the overload allowable ranges are set between the loading values and a minimum duty loading value of the power supply modules.

11. The method of claim 1, wherein the overload allowable ranges are set between the loading values and a maximum duty loading value of the power supply modules.

12. The method of claim 1, wherein the overload allowable ranges are set between a minimum duty loading value and a maximum duty loading value of the power supply modules.

13. An apparatus for implementing a method for processing abnormal conditions of a backup-type power supply system, comprising:
a plurality of power supply modules;
a power loading balance unit connecting electrically to the power supply modules to determine duty loading values of the individual power supply modules according to a total power loading value to be provided and deliverable output power loading values of the individual power supply modules; and
a logic determination unit to detect the duty loading values of the individual power supply modules and preset an overload allowable range, and issue a driving signal to execute a corresponding process for abnormal conditions when the duty loading values exceed the overload allowable range.

14. The apparatus of claim 13, wherein the driving signal is output to the power supply modules to cut off output power of the power supply modules.

15. The apparatus of claim 13, wherein the logic determination unit further outputs an alarm signal to an alarm unit.

16. The apparatus of claim 15, wherein the alarm unit is a light emitting element, an audio output element or a combination thereof.

17. The apparatus of claim 15, wherein the logic determination unit is connected to a timing unit to issue the driving signal after activated and a selected time period elapsed when the alarm signal is generated to cut off output power of the power supply modules.

18. The apparatus of claim 13, wherein the logic determination unit further outputs a display signal to a display unit.
